(19) United States
(12) Patent Application Publication
(10) Pub. No.: US 2012/0246554 A1
(43) Pub. Date: Sep. 27, 2012

(54) PERFORMING BINARY COMPOSITION OF IMAGES ONTO AN HTML CANVAS ELEMENT

(75) Inventor: Dan Shappir, Tel Aviv (IL)

(73) Assignee: ERICOM SOFTWARE LTD., Jerusalem (IL)

(21) Appl. No.: 13/414,735

(22) Filed: Mar. 8, 2012

Related U.S. Application Data
(63) Continuation-in-part of application No. 61/466,546, filed on Mar. 23, 2011.

(51) Int. Cl. G06F 17/20

(52) U.S. Cl. 715/234

(57) ABSTRACT

A computer draws an image by issuing an instruction to create a target HTML5 canvas, issuing an instruction to perform binary composition of a color of each pixel of at least a first portion of the target canvas and a color obtained from a color source such as a corresponding pixel of a source HTML5 canvas, issuing an instruction to paint a result of the binary composition onto at least a second portion of the target canvas, and rendering an image of the target canvas.

This is a continuation-in-part of U.S. Provisional Patent Application No. 61/466,546, filed Mar. 23, 2011

### FIELD AND BACKGROUND OF THE INVENTION

The invention relates to the field of computer graphics and the rendering of images inside of a Web browser. More specifically, the invention relates to performing drawing operations and the rendering of images on an HTML canvas element. The canvas element is part of the HTML5 standard. The canvas element was introduced in order to allow for dynamic, scriptable rendering of shapes and bitmap images. The canvas element utilizes a low level, procedural model that updates a bitmap and does not have a built-in scene graph.

The HTML5 standard is an update and revision of HTML (HyperText Markup Language), which is the predominant markup language for Web pages. As such, HTML comprises the basic building-blocks of Web pages. The Web Hypertext Application Technology Working Group (WHATWG) began work on the new standard for HTML in 2004, under the name Web Applications 1.0. Starting in 2009, the World Wide Web Consortium (W3C) joined with WHATWG to work together on the new standard, which was renamed to HTML5. As of January 2011, the specification is in the Draft Standard state at the WHATWG and in Working Draft state at the W3C. While the HTML5 specification is still being developed at this time, some sections of it are already stable and there are implementations that are close to completion and can be used today, specifically of the canvas element. In particular, the latest versions of the most common Web browsers, such as Microsoft Internet Explorer™, Mozilla Pirefox™, Google Chrome™ and Apple Safari™, implement the canvas element in accordance with the existing specification.

A significant portion of the HTML5 standard is the specification of scripting application programming interfaces (APIs). These APIs are accessible from scripting languages that are executed by the browser, such as the JavaScript™ programming language. Additional programming languages executed by browsers that may be able to access the APIs include various variations of the ECMAScript standard such as Microsoft JScript™ and other scripting languages such as Microsoft VBScript™. In this document the term JavaScript will be used to represent all such languages as JavaScript is by far the most prevalent scripting language used in browsers, and is the term used in most standards documents.

One of the new APIs introduced in HTML5 is the canvas element for immediate mode drawing. A “canvas” consists of a drawable region defined in HTML code with height and width attributes. JavaScript code may access the area through a set of drawing functions similar to other common drawing APIs, thus allowing for dynamically generated graphics. Some anticipated uses of canvas include building graphs, animations, games, and image composition.

The canvas API supports two dimensional (2D) drawing operations, such as drawing lines, filling regions, and drawing images onto the canvas area. This is accomplished by programmatically obtaining a 2D drawing context for a canvas element in the HTML using the getContext method. The 2D drawing context is represented to the JavaScript code as an object that provides a set of standard methods for drawing onto the canvas, for example the fillRect method draws a filled rectangle at a specified location within the canvas and at a specified size. Likewise, drawing an image onto the canvas is performed using the drawImage method.

In addition to drawing, the 2D drawing context also provides standard APIs for direct manipulation of canvas pixels as data. The getImageData method retrieves the values of a rectangle of pixels as an array of numeric values that can be directly read and modified by JavaScript code. Each pixel is represented by four one-byte values (red, green, blue, and alpha, in that order; that is, “RGBA” format). Each color component is represented by an integer between 0 and 255. Each component is assigned a consecutive index within the array, with the top left pixel's red component being at index 0 within the array. Pixels then proceed from left to right, then downward, throughout the array. Modifying the data retrieved by getImageData does not directly update the content of the canvas. Instead this data can be “painted” onto a canvas using the putImageData method. It is also possible to create blank image data using the createImageData method.

Future browser versions may introduce additional representations of canvas pixel data, such as a single 32-bit numerical value or a string value in the format “#rrggbbaa”. The present invention applies to all such existing or future pixel data representations.

The 2D drawing APIs also provide methods for performing composition of images and other drawing operations onto a canvas surface. In particular, the composition is controlled by the globalCompositeOperation property of the 2D context object. The composition is performed based on the alpha values of each pixel. This method is known in the field of computer graphics as “alpha compositing”. The alpha value of each pixel represents its matte, which determines coverage information—the shape of the geometry being drawn—making it possible to distinguish between parts of the image where the geometry was actually drawn and other parts of the image that are empty (in this context, the alpha value is sometimes referred to as the “alpha channel”).

What is lacking in the HTML5 canvas 2D drawing API is a method for performing binary composition based on the color value the pixels, such as the red, green, and blue values, independently of the alpha value. Binary composition based on the color values of the pixels would be accomplished by computing the results of a binary operation that is applied to the red, green, and blue values irrespective of the alpha value. For example, a binary composition using XOR of a pixel that has a red value of 2A hexadecimal (42 decimal), a green value of 3B hexadecimal (59 decimal), and a blue value of 4C hexadecimal (76 decimal) with the red value of 7E hexadecimal (126 decimal), a green value of 6D hexadecimal (109 decimal), and a blue value of 5C hexadecimal (92 decimal), would yield:

54=2A XOR 7E

56=3B XOR 6D

10=4C XOR 5C

which is a red value of 54 hexadecimal (84 decimal), a green value of 56 hexadecimal (86 decimal), and a blue value of 10 hexadecimal (16 decimal). The value of the alpha channel may be unaltered by the operation, or set to a particular value or computed as well. Additional binary operations include AND, OR, and NAND. The unary NOT operation would be applied to either the original pixel values or the values composited with the original pixel values prior to the binary operations.

The lack of support for binary composition utilizing pixel color values in the HTML5 standard is a significant deficiency in several useful scenarios. For example, this lack of support can prevent porting of drawing algorithms or of applications that were developed on systems that do support binary composition utilizing the color values. A specific example is the implementation of a client for a remote presentation protocol, such as Remote Desktop Protocol (RDP), using HTML5 and JavaScript. RDP is a protocol developed by Microsoft for remote access to Windows™ desktops and applications. Microsoft has implemented RDP so that it supports transmission of encoded drawing operations from the server to the client. This was done because it can be more efficient to transmit drawing operations that construct an image rather than the image itself. These drawing operations are executed by the client to construct the image. Drawing operations specified by RDP utilize binary composition based on color values of pixels rather than composition based on alpha values. As a result, without having a method for implementing binary composition utilizing color values for HTML5 canvas, it is not possible to utilize HTML5 canvas to execute all the RDP-encoded drawing operations. It is therefore desirable to provide a method for implementing binary composition utilizing color values for the HTML5 canvas API, without requiring changes to the HTML5 standard or updates of the canvas API.

### DEFINITIONS

The scope of the term “HTML5” as used in the appended claims is to be understood as referring both to HTML5 itself and to all future derivatives of HTML that are backward-compatible with HTML5. The term “canvas” as used in the appended claims is to be understood as referring both to the HTML5 canvas element and to the corresponding element of all future derivatives of HTML that are backward-compatible with HTML5.

### SUMMARY OF THE INVENTION

According to the invention there is provided a method for performing binary composition using color values on an HTML5 canvas element, without requiring changes to the canvas API, as defined by the HTML5 standard. A Web browser that supports the canvas element as defined in the HTML5 specification, and also supports the JavaScript programming language, displays a Web page that contains one or more canvas elements. A drawing operation that utilizes binary composition is performed onto the one or more canvas elements. The one or more canvas elements are referred to herein as the target canvas. The drawing operation that utilizes binary composition is accomplished by performing the same drawing operation without binary composition onto one or more additional canvas elements that are not visible to the user. The one or more additional canvas elements are referred to herein as the source canvas. getImageData is then used to obtain the pixel data of the relevant areas on both the target canvas and the source canvas. JavaScript code then processes each pixel data retrieved from both the source and target canvases, performing binary composition between the color data of matching pixels. The result of the computation of the binary composition either is written back into the pixel data retrieved from either the source or target canvases or is writtten into new pixel data created using createImageData. The pixel data containing the result of the computation is then painted onto the target canvas using putImageData. This results in the target canvas containing the result of a drawing operation that utilizes binary composition, as desired.

Therefore, according to the present invention there is provided a method for a computer to draw an image, including the steps of: (a) issuing an instruction to create a target HTML5 canvas; (b) issuing an instruction to perform a binary composition of a respective color of each pixel of at least a first portion of the target HTML5 canvas and a color obtained from a color source; (c) issuing an instruction to paint a result of the binary composition onto at least a second portion of the target HTML5 canvas; and (d) rendering an image of the target HTML5 canvas.

Furthermore, according to the present invention there is provided a computer-readable storage medium having embedded thereon computer-readable code for drawing an image, the computer-readable code including: (a) computer-readable code, for creating a target HTML5 canvas, selected from the group consisting of an instruction to create said target HTML5 canvas and a reference to an instruction to create said target HTML5 canvas; and (b) an instruction to perform a binary composition of a respective color of each pixel of at least a first portion of the target HTML5 canvas and a color obtained from a color source.

The basic method of the present invention is a method that a computer uses to draw an image. Typically, the computer is a client that runs the code of a Web is browser for that purpose. The image usually is drawn by displaying it on a display screen or by printing a hardcopy, but also could be “drawn” as an image file such as a .tiff file or a .jpg file in a non-volatile storage medium.

In the first step of the basic method, the computer issues one or more instructions to create a target HTML5 canvas. Such instructions are coded in HTML5 or in JavaScript code embedded in or referenced by the HTML5 code. “Issuing” an instruction means that the processor of the computer executes the code of the instruction, for example by executing the code of an interpreter of the language in which the instruction is encoded. In the second step of the basic method, the computer issues one or more JavaScript instructions to perform a binary composition of a respective color of each pixel of at least a first portion of the target HTML5 canvas and a color obtained from a color source such as a pixel of a source HTML5 canvas or such as a scripting language data structure. In the third step of the basic method, the computer issues one or more JavaScript instructions to paint a result of the binary composition onto at least a second portion of the target HTML5 canvas. Often, the two portions of the target HTML5 canvas are identical, i.e., the result of the binary composition is painted back onto at least the first portion itself of the target HTML5 canvas. In the fourth step of the basic method, the computer renders an image of the target HTML5 canvas. The image could be a real image such as a display on a display screen or a hardcopy. Alternatively, the image could be a persistent (i.e., non-transitory) virtual image such as an image file in a non-volatile storage medium.

If the color source is a pixel of a source HTML5 canvas, then preferably the method includes the step of the computer issuing one or more instructions to create the source HTML5 canvas, and the color that is obtained from the color source is a respective color of that pixel of the source HTML5 canvas. As in the case of the first step of the basic method, the instruction(s) for creating the source HTML5 canvas usually is/are encoded in HTML5 but alternatively could be encoded in JavaScript. Most preferably, the source HTML5 canvas is created without rendering the source HTML5 canvas as a real image.

Preferably, before the result of the binary composition is painted in the at least second portion of the target HTML5 canvas, the results of the binary composition are stored, either in pixel data retrieved from the target HTML5 canvas, or in pixel data retrieved from the color source (e.g., if the color source is a source HTML5 canvas, in pixel data retrieved from the source HTML5 canvas), or in pixel data that are independent of the target HTML5 canvas and of the color source, or in a container object of a scripting language.

A basic computer-readable storage medium of the present invention has embedded thereon at least computer-readable code of the instructions of the first two steps of the basic method, or else computer-readable code of a reference to the instruction(s) of the first step of the basic method and computer-readable code of the instruction(s) of the second step of the basic method. One example of code of a reference to (an) instruction(s) is a URL of a file that includes the instruction(s). Preferably, the storage medium also has embedded thereon computer-readable code of the instruction(s) of the third step of the basic method.

### BRIEF DESCRIPTION OF THE DRAWINGS

Various embodiments are herein described, by way of example only, with reference to the accompanying drawings, wherein:

FIG. 1 is a partial, high-level block diagram of an Internet server configured according to the present invention;

FIG. 2 is a partial, high-level block diagram of a client of the server of FIG. 1.

### DESCRIPTION OF THE PREFERRED EMBODIMENTS

The principles and operation of binary composition according to the present invention may be better understood with reference to the drawings and the accompanying description.

The invention is a method of performing drawing operations that utilize binary composition of color values, such as red, green, and blue, onto canvas elements as defined in the HTML5 specification, without requiring changes to the HTML5 standard. Specifically, in the method, drawing is performed utilizing the programmatic drawing operations detailed in the interface of the canvas elements 2D drawing context as described in the HTML5 specification. Also specifically in the method, the resulting image in the canvas elements is the binary composition using the color values of the drawing operations and the content of the canvas elements before the drawing operations were performed.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In one aspect, embodiments of the invention feature a method that performs drawing operations that utilize binary composition of the color values onto HTML canvas elements. Given a Web page specified using HTML code and associated JavaScript code, which is embedded in the page or referenced by the page. And given a Web browser which receives or loads the HTML code and JavaScript code, rendering the HTML code and executing the JavaScript code to create the display for the Web page. And given that the HTML code contains one or more canvas elements onto which drawing operations that utilize binary composition of the color values need to be performed. These canvas elements are referred to herein as the target canvas. And given that the HTML code contains one or more additional canvas elements that are not visible to the user. These canvas elements are referred to herein as the source canvas. The preferred embodiment of the method includes the following steps:
1. Performing a drawing operation onto the source canvas without binary composition.
2. Using getImageData to obtain the pixel data for a rectangle that contains the area of the source canvas modified in step 1.
3. Using getImageData to obtain the pixel data for a rectangle that contains the area that needs to be modified in the target canvas.
4. Programmatically processing each pixel data retrieved from both the source and target canvases, performing binary composition between the color data of matching pixels.
5. Storing the result of the composition in the pixel data retrieved from the target canvas.
6. Painting the pixel data containing the result onto the target canvas for the same rectangle as specified in step 3.

In another aspect of embodiments of the invention, the result of the composition is stored in the pixel data retrieved from the source canvas (modification of step 5). Then the pixel data retrieved from the source canvas is painted on the target canvas (modification of step 6).

In another aspect of embodiments of the invention, the result of the composition is stored in new pixel data created using createImageData (modification of step 5). Then the new pixel data is painted on the target canvas (modification of step 6).

In another aspect of embodiments of the invention, the result of the composition is stored in pixel data obtained using getImageData from some other canvas or from a different location in the source or target canvases (modification of step 5). Then the pixel data is painted on the target canvas (modification of step 6).

In another aspect of embodiments of the invention, standard JavaScript arrays or other JavaScript container objects are used is intermediary storage before or after computing the binary compositions.

In another aspect of embodiments of the invention, the order of operations is modified so that getting the pixel data for the target canvas (step 3) is performed before step 2 or before step 1.

In another aspect of embodiments of the invention, pixel data from the target canvas and/or the source canvas are retrieved and processed as multiple smaller pixel data items, via multiple calls to getImageData and putImageData, instead using one pixel data item for each.

In another aspect of embodiments of the invention, the target canvas and/or the source canvas are created dynamically by JavaScript instead of being specified in the HTML.

In another aspect of embodiments of the invention, multiple drawing operations are performed onto the source canvas before performing the binary composition using color values (modification of step 1).

The source of the color with which a target canvas pixel is composited does not have to be a source canvas as such. The source of the color with which a target canvas pixel is composited could be a JavaScript data structure, or the return value of a JavaScript function, for example for compositing the colors of some or all of the pixels of a target canvas with a constant color value.

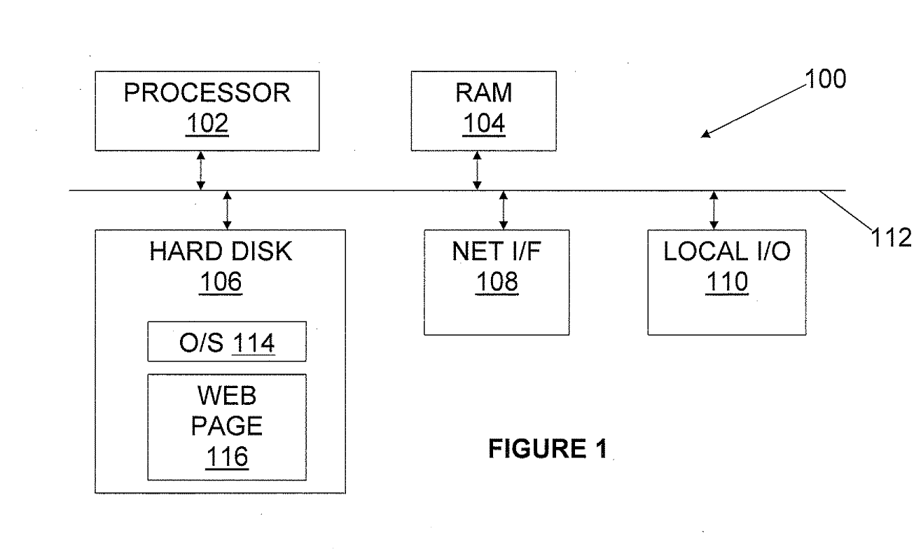

Referring now to the drawings, FIG. 1 is a partial, high-level block diagram of an Internet server 100 configured according to the present invention to send Web pages to clients. Server 100 includes:
a processor 102
a random access memory (RAM) 104
a hard disk 106
an interface 108 to a network such as the Internet
local input and output (I/O) devices 110, such as a keyboard, a printer, a disk drive, and/or USB ports for interfacing such peripheral devices with server 100
   all communicating with each other via a common bus 112. In hard disk 108 there is stored code for an operating system 114 and HTML5 and JavaScript code of one or more Web pages 116. The code of Web pages 116 includes code as described above for binary composition based on color values. Processor 102 controls server 100 by loading operating system 114 into RAM 104 and executing the code of operating system 114 in RAM 104. Operating system 114 includes code for sending Web page 116 to a client when a request for Web page 116, in the form of a URL of Web page 116, is received via interface 108.

Hard disk 106 is an example of a non-volatile computer-readable storage medium that has embedded thereon computer-readable code for implementing the method of the present invention. Other examples of such computer-readable storage media include CDs, DVDs and flash disks.

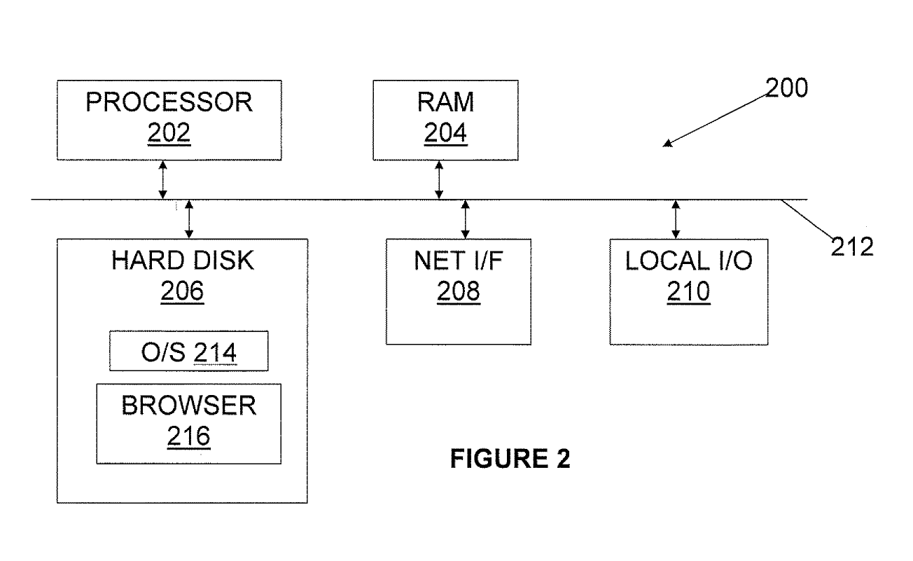

FIG. 2 is a partial, high-level block diagram of a client 200 of server 100. Client 200 includes:
a processor 202
a random access memory (RAM) 204
a hard disk 206
an interface 208 to a network such as the Internet
local input and output (I/O) devices 210, such as a keyboard, a printer, a disk drive, and/or USB ports for interfacing such peripheral devices with client 200
   all communicating with each other via a common bus 212. In hard disk 208 there is stored code for an operating system 214 and code of a Web browser 216. Processor 202 controls client 200 by loading operating system 214 into RAM 204 and executing the code of operating system 214 in RAM 204. Operating system 214 includes code for loading the code of Web browser 216 into RAM 204 and for invoking the execution of the code of Web browser 216 in RAM 204. The code of Web browser 216 includes code for sending the URL of Web page 116 to server 100 via interface 208, receiving the code of Web page 116 via interface 208, storing the code of Web page 116 in RAM 204, and executing the code of Web page 116 to create one or more target canvases as described above and to render images of the target canvases, for example, by displaying the images on a display screen that is included among I/O devices 210 and/or by printing hardcopies of the images at a printer that is included among I/O devices 210. Typically, the code of Web page 116 is executed by processor 202 loading the code of a HTML5 interpreter (not shown) and of a JavaScript interpreter (not shown) from hard disk 206 into RAM 204 and executing the code of the interpreters in RAM 204.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for a computer to draw an image, comprising the steps of
(a) issuing an instruction to create a target HTML5 canvas;
(b) issuing an instruction to perform a binary composition of a respective color of each pixel of at least a first portion of said target HTML5 canvas and a color obtained from a color source;
(c) issuing an instruction to paint a result of said binary composition onto at least a second portion of said target HTML5 canvas; and
(d) rendering an image of said target HTML5 canvas.

2. The method of claim 1, wherein said instruction that creates said target HTML5 canvas is an HTML instruction.

3. The method of claim 1, wherein said instruction that creates said target HTML5 canvas is a scripting language instruction.

4. The method of claim 1, wherein said color source is a pixel of a source HTML5 canvas and wherein said color that is obtained from said color source is a respective color of said pixel of said source HTML5 canvas, the method further comprising the step of:
(d) issuing an instruction to create said source HTML5 canvas.

5. The method of claim 4, wherein said instruction that creates said source HTML5 canvas is an HTML instruction.

6. The method of claim 4, wherein said instruction that creates said source HTML5 canvas is a scripting language instruction.

7. The method of claim 4, wherein said source HTML5 canvas is created without rendering said source HTML5 canvas as a real image.

8. The method of claim 4, further comprising the step of:
(e) storing said result of said binary composition in pixel data retrieved from said source HTML5 canvas prior to said painting of said result of said binary composition in said at least second portion of said target HTML5 canvas.

9. The method of claim 1, further comprising the step of:
(d) storing said result of said binary composition in pixel data retrieved from said target HTML5 canvas prior to said painting of said result of said binary composition in said at least second portion of said target HTML5 canvas.

10. The method of claim 1, further comprising the step of
(d) storing said result of said binary composition in pixel data retrieved from said color source prior to said painting of said result of said binary composition in said at least second portion of said targeet HTML5 canvas.

11. The method of claim 1, further comprising the step of:
(d) storing said result of said binary composition in pixel data that are independent of said target HTML5 canvas and of said color source prior to said painting of said result of said binary composition in said at least second portion of said targeet HTML5 canvas.

12. The method of claim 1, further comprising the step of:
(d) storing said result of said binary composition in a container object of a scripting language prior to said painting of said result of said binary composition in said at least second portion of said target HTML5 canvas.

13. The method of claim 1, wherein said color source is a scripting language data structure.

14. The method of claim 1, wherein said second portion of said target HTML5 canvas is identical to said first portion of said target HTML5 canvas.

15. The method of claim 1, wherein said image is a real image.

16. The method of claim 1, wherein said image is a persistent virtual image.

17. A computer-readable storage medium having embedded thereon computer-readable code for drawing an image, the computer-readable code comprising:
(a) computer-readable code, for creating a target HTML5 canvas, selected from the group consisting of an instruction to create said target HTML5 canvas and a reference to an instruction to create said target HTML5 canvas; and
(b) an instruction to perform a binary composition of a respective color of each pixel of at least a first portion of said target HTML5 canvas and a color obtained from a color source.

18. The computer-readable storage medium of claim 16, wherein the computer-readable code further comprises:
(c) an instruction to paint a result of said binary composition onto at least a second portion of said target HTML5 canvas.
